(19) United States
(12) Patent Application Publication
(10) Pub. No.: US 2008/0218681 A1
(43) Pub. Date: Sep. 11, 2008

(54) Eyesight correction lens

(75) Inventor: Ching-Fu Chuang, Tainan City (TW)

Correspondence Address: Ching-Fu CHUANG, P.O. BOX 6-9 (717), Tainan, TW

(73) Assignee: JIHN MEI OPTICAL CO., LTD.

(21) Appl. No.: 11/715,707

(22) Filed: Mar. 9, 2007

(51) Int. Cl. G02C 7/08

(52) U.S. Cl. 351/57

(57) ABSTRACT

An eyesight correction lens includes a seeing region and a combining surface that is made of a material able to be sucked on a smooth lens. The eyesight correction lens can be positioned on the lens of eyeglasses so that a person with poor eyesight can not only protect his eyes but also see things clearly through the seeing region of the eyesight correction lenses. Since the seeing region of the eyesight correction lens does not contact with the lens of the eyeglasses, no air bubbles will be produced therebetween and hence things can be seen clearly through them. The eyesight correction lens of this invention can be combined on the lens of different eyeglasses for use and also can be removed from the eyeglasses when a user need not see things at a short distance, convenient in use.

### BACKGROUND OF THE INVENTION

1. Field of the Invention

This invention relates to an eyesight correction lens, particularly to one able to be combined at a lower portion of the lens of eyeglasses, but not contact with the lens of the eyeglasses, convenient in use.

2. Field of the Prior Art

There are various kinds of eyeglasses with different functions, such as eyeglasses for the nearsighted and for the presbyopic, sunglasses and goggles for protecting eyes, or the like. All these kinds of eyeglasses have practical effects so they are widely used.

The goggles, for instance, are able to protect a user's eyes form being hurt but, as commonly known, when the user's eyesight is growing poor with age and becomes presbyopic or nearsighted, the goggles will be unable to let the user to see things clearly. Although there are various kinds of eyeglasses with different degrees for the presbyopic and for the nearsighted, yet if a person who is presbyopic or nearsighted and wears goggles wants to watch things at a short distance, he/she has to remove the goggles and put on persbyopia eyeglasses and, after finishing using, he/she has to remove the presbyopia eyeglasses and put on the goggles again, thus resulting in much inconvenience. If the lenses of goggles are made of eyesight correction lenses when a presbyopic person wears such goggles, he will be unable to clearly see thing at a distant place, equally causing much trouble in use. To improve the above-mentioned drawbacks, goggles could have their lenses adhered thereon with eyesight correction lenses, as disclosed in two U.S. Pat. No. 5,793,467 and U.S. Pat. No. 6,003,990. However, by so designing, air bubbles may be produced between the lens of the goggles and the eyesight correction lens; therefore, a part of the lens may become vague and lose fidelity.

### SUMMARY OF THE INVENTION

The objective of this invention is to offer an eyesight correction lens able to be combined on the lenses of any kind of eyeglasses, convenient and practical in use.

The eyesight correction lens in the present invention is provided with a seeing region, which is a lens with an optical degree, and a combining surface protruding out of the seeing region.

### BRIEF DESCRIPTION OF DRAWINGS

This invention will be better understood by referring to the accompanying drawings, wherein:

FIG. 1 is an exploded perspective view of a first preferred embodiment of eyeglasses and eyesight correction lenses in the present invention;

FIG. 2 is a perspective view of the first preferred embodiment of the eyeglasses combined with the eyesight correction lenses in the present invention;

FIG. 3 is a side cross-sectional view of the first preferred embodiment of the eyesight correction lens in the present invention;

FIG. 4 is an exploded perspective view of a second preferred embodiment of eyeglasses and eyesight correction lenses in the present invention;

FIG. 5 is a perspective view of the second preferred embodiment of the eyeglasses combined with the eyesight correction lenses in the present invention;

FIG. 6 is a side cross-sectional view of the second preferred embodiment of the eyesight correction lens in the present invention;

FIG. 7 is an exploded perspective view of a third preferred embodiment of eyeglasses and eyesight correction lenses in the present invention;

FIG. 8 is a perspective view of the third preferred embodiment of the eyeglasses combined with the eyesight correction lenses in the present invention;

FIG. 9 is a side cross-sectional view of the third preferred embodiment of the eyesight correction lens in the present invention;

FIG. 10 is an exploded perspective view of a fourth preferred embodiment of eyeglasses and eyesight correction lenses in the present invention;

FIG. 11 is a perspective view of the fourth preferred embodiment of the eyeglasses combined with the eyesight correction lenses in the present invention; and

FIG. 12 is a side cross-sectional view of the fourth preferred embodiment of the eyesight correction lens in the present invention.

### DETAILED DESCRIPTION OF THE PREFERRED EMBODIMENT

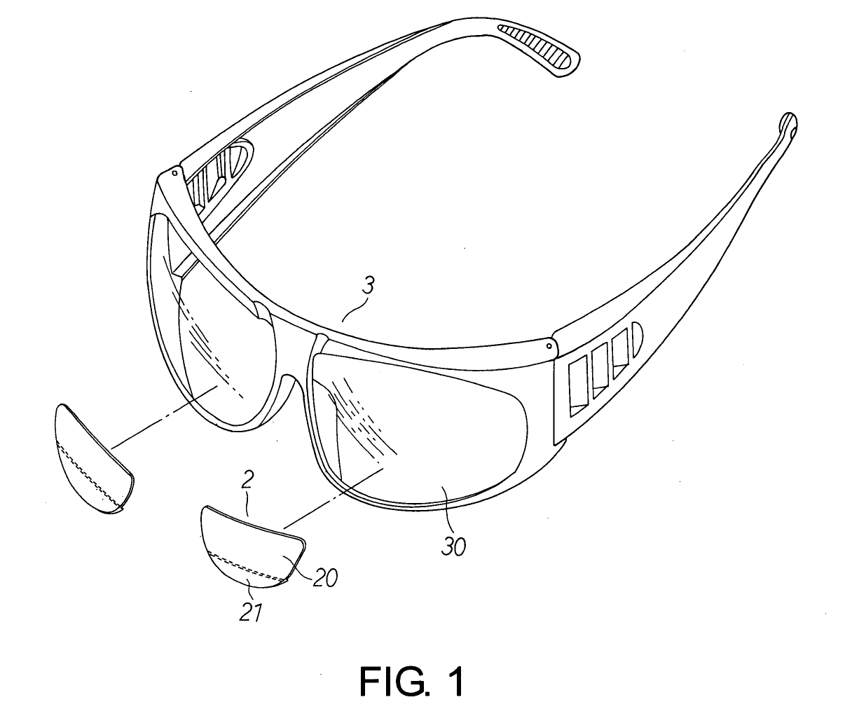

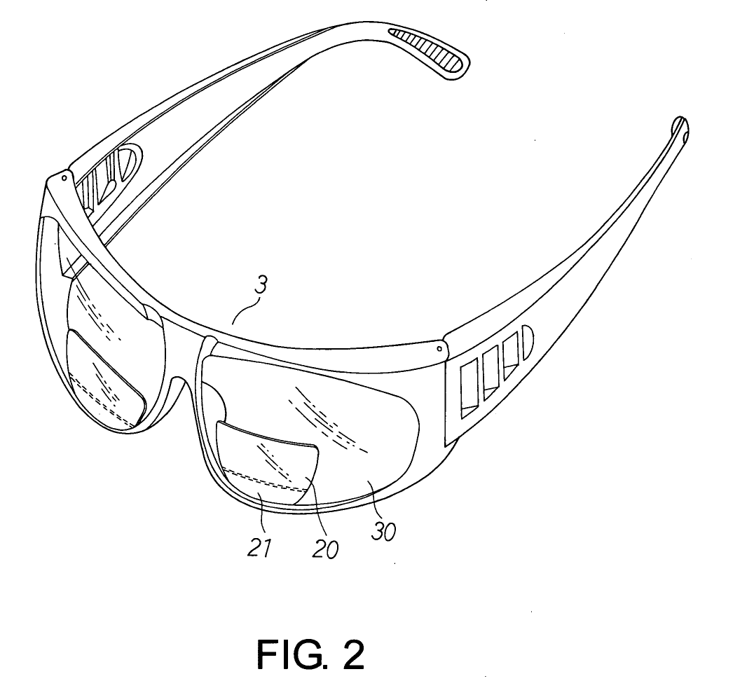

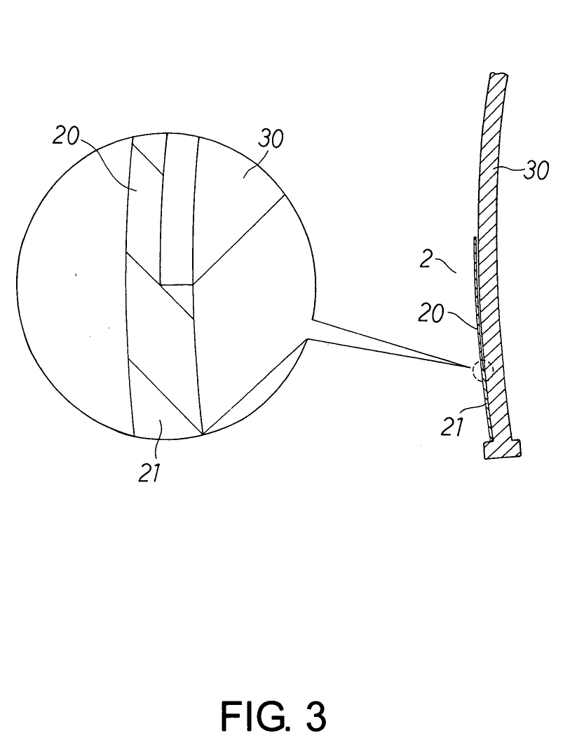

A first preferred embodiment of an eyesight correction lens in the present invention, as shown in FIGS. 1, 2 and 3, is a presbyopic lens 2. The presbyopia lens 2 shaped as an inverted semicircle is composed of a seeing region 20 and a stepped combining surface 21 higher than the seeing region 20 by several millimeters, as shown in FIG. 3. The combining surface 21 is made of a material able to be sucked on the lens of eyeglasses.

In using, the presbyopic lens 2 has its combining surface 21 combined at a proper location on the inner lower portion of the lens 30 of the goggles 3 a presbyopic person wears, letting the seeing region 20 of the presbyopic lens 2 aligned to the lower side of a user's visional range. Since the seeing region 20 of the presbyopic lens 2 is separated from the lens 30 of the goggles 3 for several millimeters, no air bubbles will be produced between them, and hence things can be seen clearly and accurately through the lens 30 of the goggles 3 and the seeing region 20 of the presbyopic lens 2.

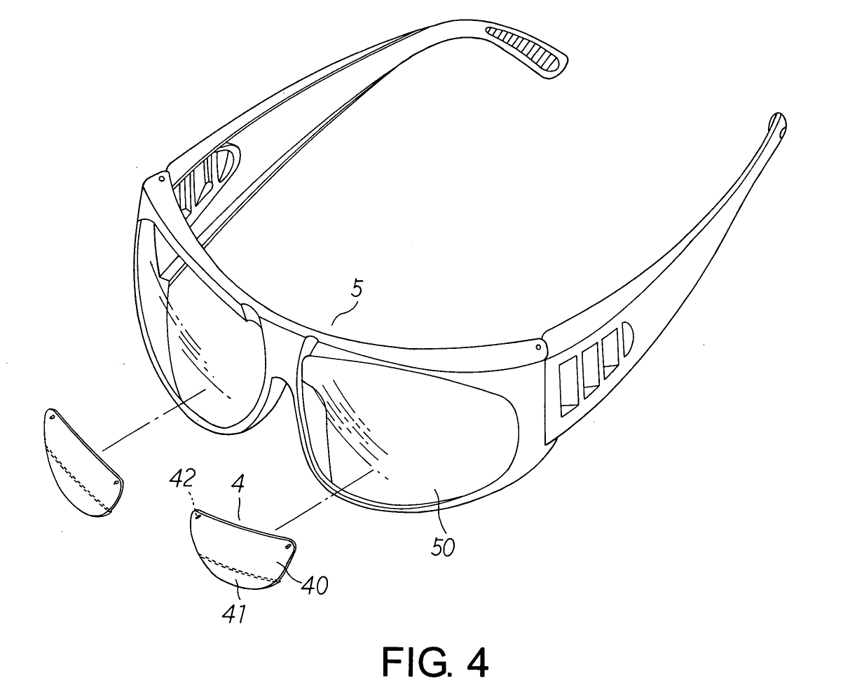

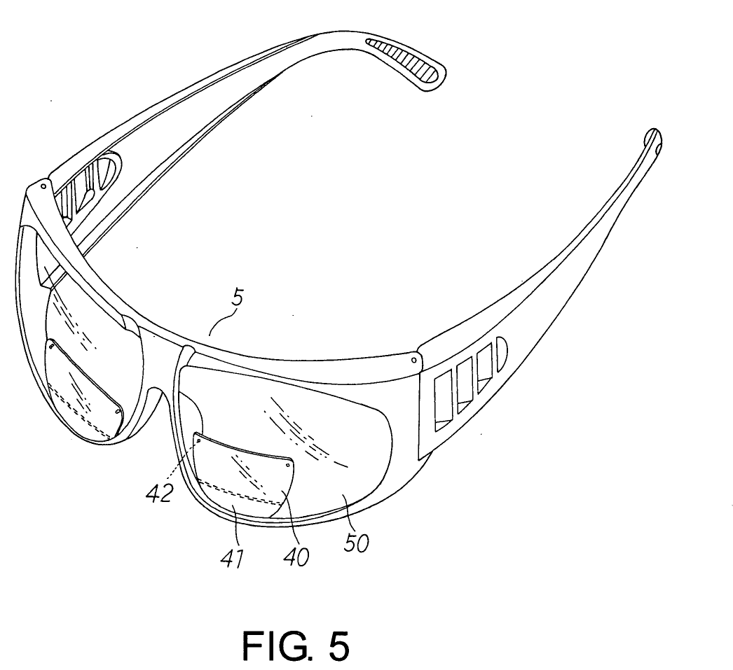

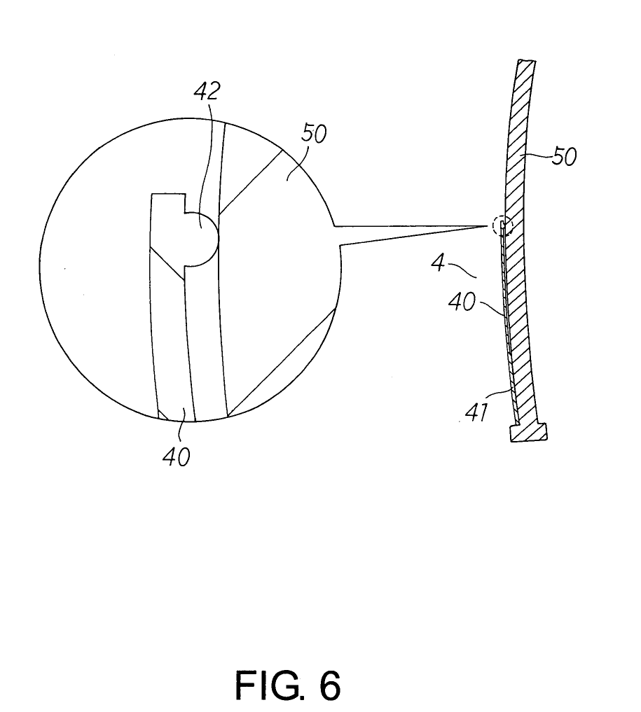

A second preferred embodiment of an eyesight correction lens in the present invention, as shown in FIGS. 4, 5 and 6, is a presbyopic lens 4 composed of a seeing region 40 and a combining surface 41. The seeing region 40 of the presbyopic lens 4 is provided with support members 42 so as to maintain a constant interval of several millimeters between the seeing region 40 of the presbyopic lens 4 and the lens 50 of the goggles 5, impossible to change the space between the seeing region 40 of the presbyopic lens 4 and the lens 50 of the goggles 5 and not influencing visional effects.

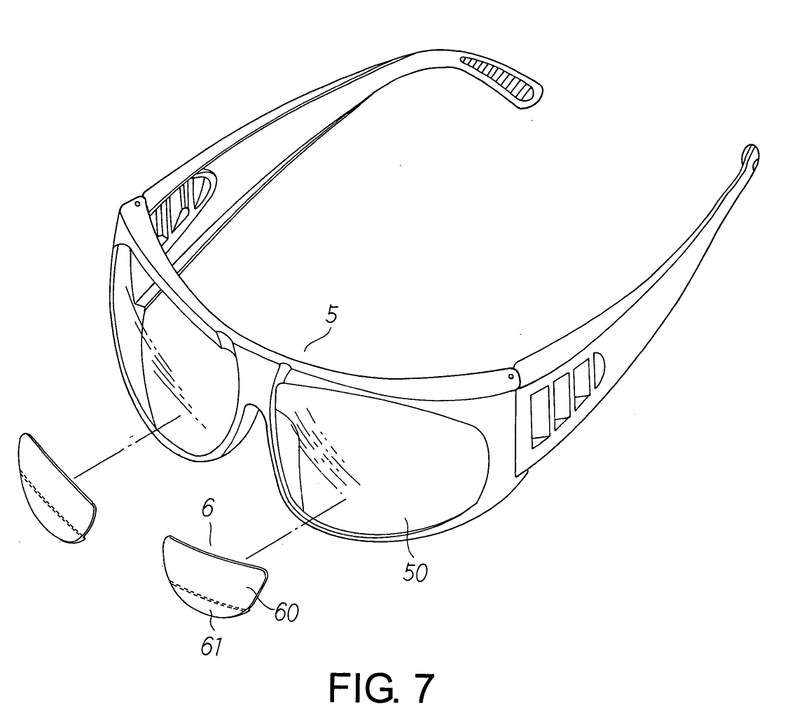

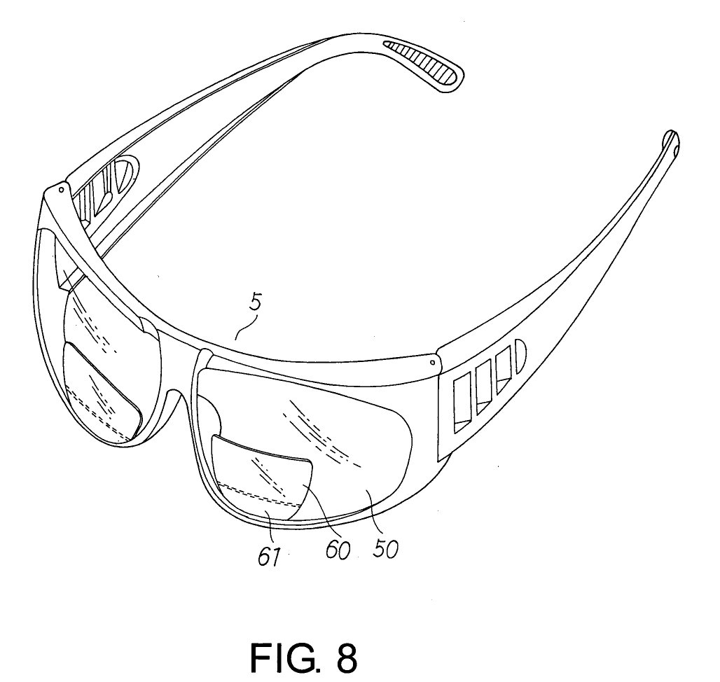

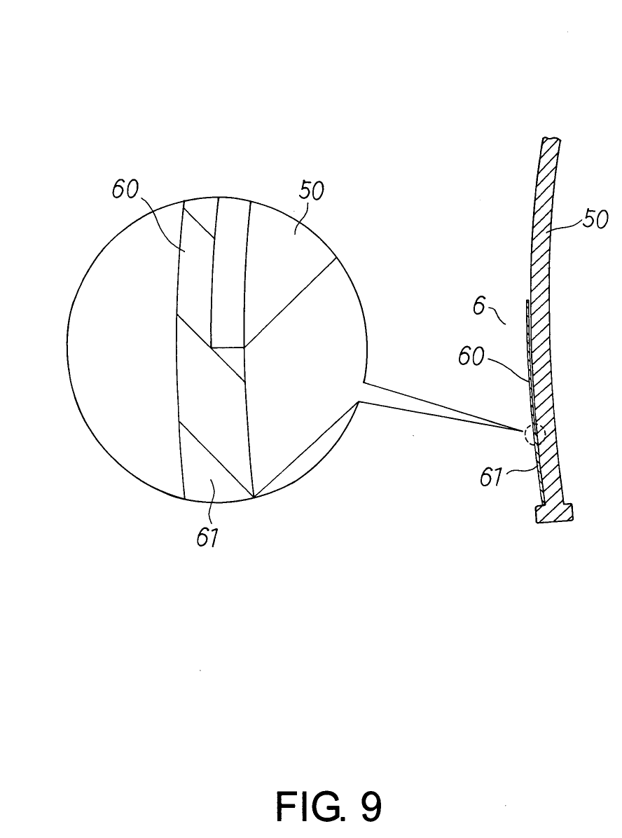

A third preferred embodiment of an eyesight correction lens, as shown in FIGS. 7, 8 and 9, is a nearsighted lens 6 shaped as an inverted semicircle and composed of a seeing region 60 and a combining surface 61. The combining surface 61 of the nearsighted lens 6 is step-shaped, higher than the seeing region 60 by several millimeters and made of a material able to be sucked on the lens of eyeglasses.

In using, the nearsighted lens 6 has its combining surface 61 combined at a proper location on the inner lower portion of the lens 50 of goggles 5, letting the seeing region 60 of the nearsighted lens 6 aligned to the lower side of a user's vision range. Since there is a constant space between the seeing region 60 of the nearsighted lens 6 and the lens 50 of the goggles 5, no air bubbles may be produced therebetween and, therefore, things can be seen clearly and accurately through the lens 50 of the goggles 5 and the seeing region 60 of the nearsighted lens 6.

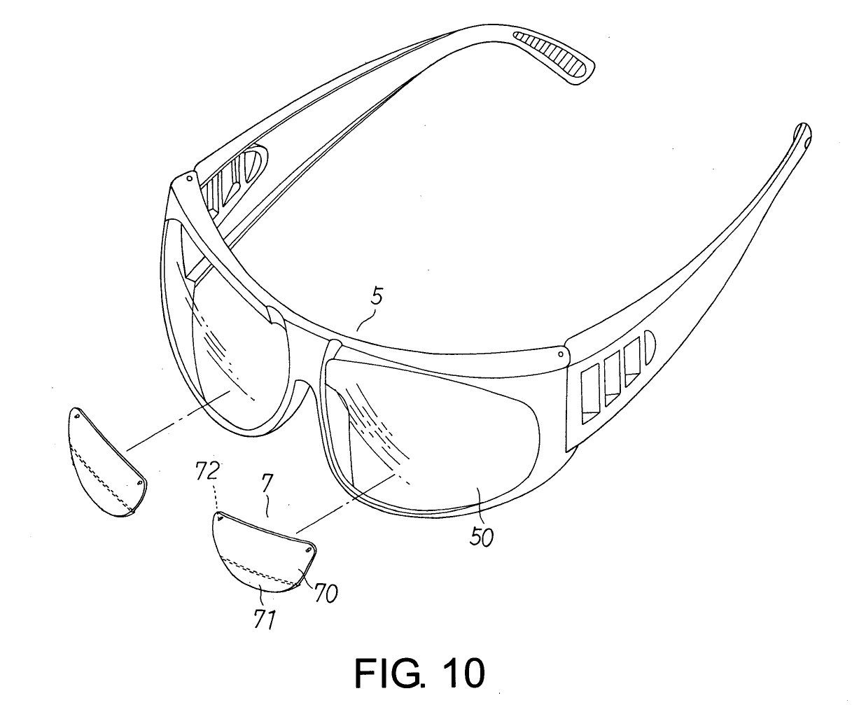

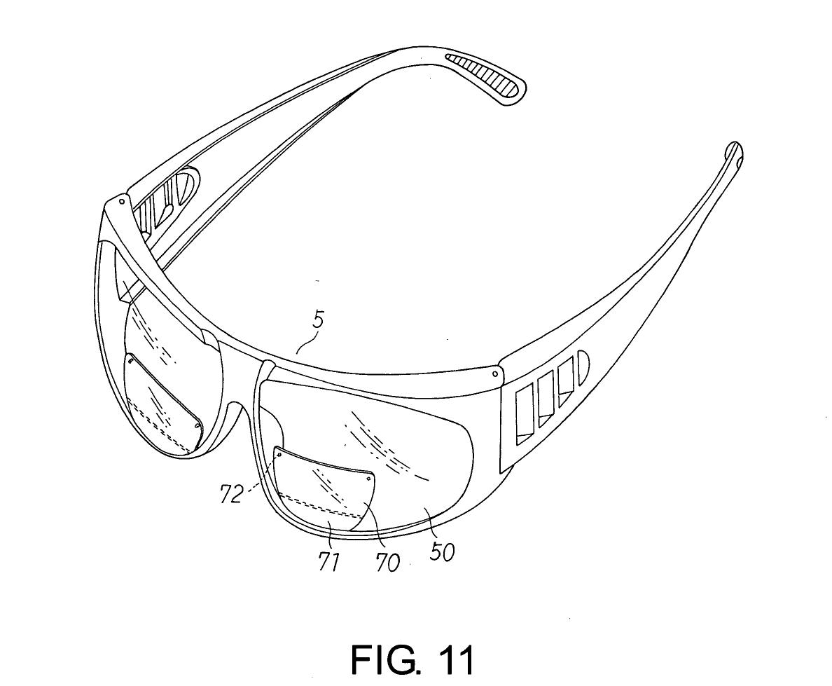

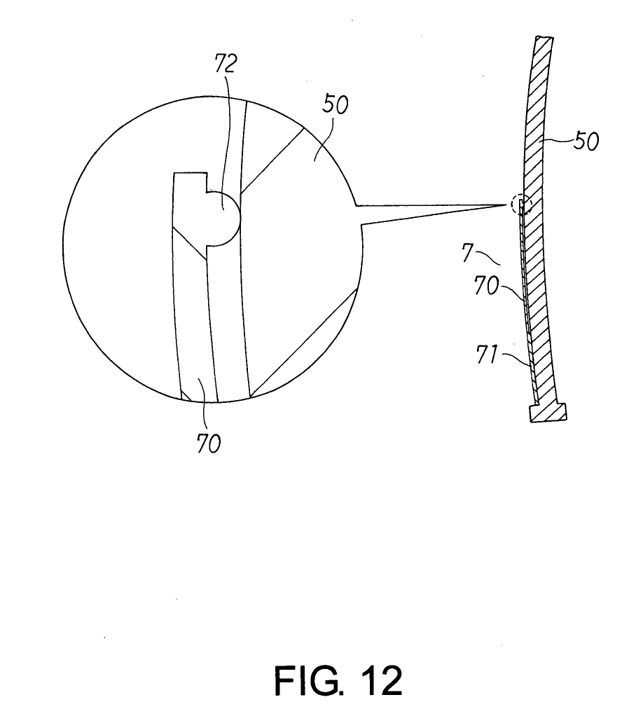

A fourth preferred embodiment of an eyesight correction lens in the present invention, as shown in FIGS. 10, 11 and 12, is a nearsighted lens 7 provided with a seeing region 70 and a combining surface 71. The seeing region 70 of the nearsighted lens 7 is provided with support members 72 for keeping a constant space of several millimeters between the seeing region 70 of the nearsighted lens 7 and the lens 50 of the goggles 5, able to stabilize the space between the seeing region 70 of the nearsighted lens 7 and the lens 50 of the goggles 5 for maintaining excellent visional effects.

As can be understood from the above description, this invention has the following advantages.

1. The presbyopic lens 2, 4 and the nearsighted lens 6, 7 of the eyesight correction lenses of this invention are respectively provided with the combining member to be combined on the lens of sunglasses or the lens of goggles for use, and the eyesight correction lenses can also be removed from the eyeglasses to be stored when a user does not need to use them, convenient to handle.

2. The presbyopic lens 2, 4 and the nearsighted lens 6, 7 of the eyesight correction lenses of this invention are not formed integral with eyeglasses; therefore, when a user's eyesight changes in degrees, it is only necessary to replace the presbyopic lenses 2, 4 or the nearsighted lenses 6, 7, thus lowering replacing cost.

3. The presbyopic lens 2, 4 and nearsighted lens 6, 7 of the eyesight correction lenses of this invention is made independently, greatly lowering producing cost.

4. The seeing region 20, 40 of the presbyopic lens 2, 4 and the seeing region 60, 70 of the nearsighted lens 6, 7 of this invention do not contact with the lens of eyeglasses, so no air bubbles will be produced therebetween to affect visional range, enabling a user to see things clearly and accurately through the seeing region of the eyesight correction lens and the lens of the goggles.

5. The seeing region 40, 70 of the eyesight correction lens are respectively provided with support members 42, 72 for maintaining a definite space between the seeing region of the eyesight correction lens and the lens of the goggles.

While the preferred embodiments of the invention have been described above, it will be recognized and understood that various modifications may be made therein and the appended claims are intended to cover all such modifications that may fall within the spirit and scope of the invention.

I claim:

1. An eyesight correction lens comprising a seeing region and a combining surface, said combining surface protruding out of said seeing region, said seeing region being a lens with an optical degree; and
said combining surface of said eyesight correction lens combined on the lens of eyeglasses, said seeing region of said eyesight correction lens separated from said lens of said eyeglasses to form a space of several millimeters, said space preventing air bubbles from produced between said seeing region of said eyesight correction lens and said lens of said eyeglasses, thus things able to be seen clearly and accurately through said seeing region of said eyesight correction lens and said lens of said eyeglasses, a presbyopic person who wears said eyeglasses combined with said eyesight correction lens able to protect his eyes and see things at a short distance at the same time, said eyesight correction lens also able to be removed from said eyeglasses when a user does not need to see things at a short distance.

2. An eyesight correction lens provided with a seeing region and a combining surface protruding out of said seeing region, said seeing region being a lens with an optical degree, said seeing region provided with support members; and
said eyesight correction lens combined on the lens of eyeglasses, said seeing region of said eyesight correction lens separated from said lens of said eyeglasses at a definite interval, things able to be seen clearly through said seeing region of said eyesight correction lens and said lens of said eyeglasses.

3. The eyesight correction lens as claimed in claim 1, wherein said seeing region of said eyesight correction lens is a nearsighted lens.

4. The eyesight correction lens as claimed in claim 1, wherein said seeing region of said eyesight correction lens is a presbyopic lens.

5. The eyesight correction lens as claimed in claim 2, wherein said seeing region of said eyesight correction lens is a nearsighted lens.

6. The eyesight correction lens as claimed in claim 2, wherein said seeing region of said eyesight correction lens is a presbyopic lens.
